(19) United States
(12) Patent Application Publication
(10) Pub. No.: US 2013/0077228 A1
(43) Pub. Date: Mar. 28, 2013

(54) PORTABLE COMPUTER ASSEMBLY

(71) Applicant: Jeffrey A. Batio, La Jolla, CA (US)

(72) Inventor: Jeffrey A. Batio, La Jolla, CA (US)

(21) Appl. No.: 13/625,590

(22) Filed: Sep. 24, 2012

Related U.S. Application Data
(60) Provisional application No. 61/537,896, filed on Sep. 22, 2011.

(51) Int. Cl. G06F 1/16

(52) U.S. Cl. 361/679.29; 361/679.27

(57) ABSTRACT

A portable computer having independently mounted screen sections, whereby the screen sections may be used to provide a larger overall screen, to provide screens mirroring each other for presentation and display, for use by different users, and the like. The screen sections are foldable and collapsible in to the main housing of the portable computer for storage and transport.

### BACKGROUND OF THE INVENTION

The deluge of information that people receive daily and need to sift through in the digital world is overwhelming to say the least. With the advent of Microsoft Windows 95/98, users can effectively multi-task by simply opening more than one program on-screen and simultaneously share data between the programs. Such sharing can be the act of inserting a digital image into a text document, or for example. Microsoft Office Suite users frequently create spreadsheet data in Microsoft Excel (charts and graphs) and then cut and paste that information into Microsoft Word in order to create complete documents. Due to the single screen nature of most PC setups, the user has to shrink each program window down significantly in order to highlight and then share the information between the program windows.

Additionally, since most computer setups feature one screen mounted in landscape (a rectangular viewing area mounted horizontally), most of the on-screen document (a piece of paper is 8.5″×11″) is lost and the user is forced to “scroll” the document down to read the entire page of text.

To remedy the landscape portion of this problem, many of today's desktop-bound LCD monitors can pivot on a frame-mounted hinge to physically rotate the screen from the inefficient landscape orientation to the far more useful and productive Portrait or vertical mode. Since most computing work requires document creation, and in most of the world a standard document is 8.5″×11.0″ (portrait) the portrait re-creation of the image onscreen saves the user considerable time and effort from not having to constantly reposition (scroll-down) the image onscreen to read a full page of text.

Moreover, due to the inefficiencies mat the single monitor screen provides, it is deemed a poor source for adding multiple Windows and dragging information between them as compared to multiple individual displays that run the individual applications full-screen per monitor.

### SUMMARY OF THE INVENTION

A Portable computer having independently mounted screen sections that can rotate, detach and reconnect is disclosed.

### CONCISE DESCRIPTION OF THE DRAWINGS

FIG. 1 is a perspective view of the subject invention with the display screens closed.

FIG. 2 is a from plan view of the subject invention of FIG. 1.

FIG. 3 is a rear plan view of the subject invention of FIG. 1

FIG. 4 is a right side plan view of the subject invention of FIG. 1.

FIG. 5 is a left side plan view of the subject invention of FIG. 1.

FIG. 6 is atop plan view of the subject ideation of FIG. 1.

FIG. 7 is a bottom plan view of the subject invention of FIG. 1.

FIG. 8 is a perspective of the subject invention of FIG. 1 showing the display screens open.

FIG. 9 is a tout plan view of the subject invention of FIG. 8.

FIG. 10 is a rear plan view of the subject invention of FIG. 8.

FIG. 11 is aright side plan view of the subject invention of FIG. 8.

FIG. 12 is a left side pm view of the subject invention of FIG. 8.

FIG. 13 is a top plan view of the subject invention of FIG. 8.

FIG. 14 is a bottom plan view of the subject invention of FIG. 8.

FIG. 15 is a perspective view of the subject invention with the display screens open, and one display screen reversed.

FIG. 16 is a front plan view of the subject invention of claim 15.

FIG. 17 is a near plan view of the subject invention of claim 15.

FIG. 18 is a right side plan view of the subject invention of claim 15.

FIG. 19 is a left side plan view of fee subject invention of claim 15.

FIG. 20 is a top plan view of the subject invention of claim 15.

FIG. 21 is a bottom plan view of the subject invention of claim 15.

FIG. 22 is a perspective view of the subject invention showing the two sides folded onto each other, with the display screen rotated backwards.

FIG. 23 is a front plan view of the subject invention of FIG. 22.

FIG. 24 is a rear plan view of the subject invention of FIG. 22.

FIG. 25 is a right side plan view of the subject invention of FIG. 22.

FIG. 26 is a left side plan view of the subject invention of FIG. 22.

FIG. 27 is a top plan view of the subject invention of FIG. 22.

FIG. 28 is a bottom plan view of the subject invention of FIG. 22.

FIG. 29 is a perspective view of a detached display screen of the subject invention.

FIG. 30 is a front plan view of a defected display screen of FIG. 28.

FIG. 31 is a rear plan view of a detached display screen of FIG. 28.

FIG. 32 is a top plan view of a detached display screen of FIG. 28.

FIG. 33 is a bottom plan view of a detached display screen of FIG. 28.

FIG. 34 is a left side plan view of a detached display screws of FIG. 28.

FIG. 35 is aright side plan view of a detached display screen of FIG. 28.

FIG. 36 is a perspective view of the display screen of the subject invention in a closed position.

FIG. 37 is a font plan view of the display screen of FIG. 36.

FIG. 38 is a rear plan view of the display screen of FIG. 36.

FIG. 39 is a right side plan view of the display semen of FIG. 36.

FIG. 40 is a left side plan view of the display screen of FIG. 36.

FIG. 41. is a top plan view of the display screen of FIG. 36.

FIG. 42 is a bottom plan view of the display screen of FIG. 36.

FIG. 43 is a perspective view of the subject invention, with the units folded together and the display screens closed.

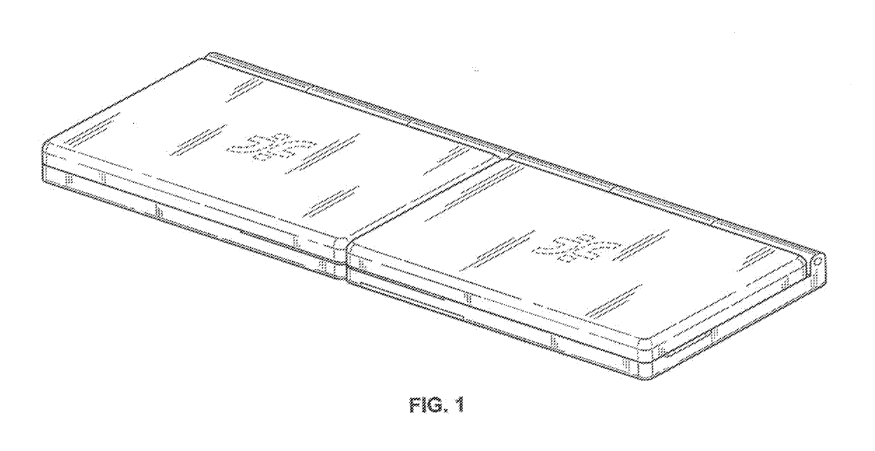

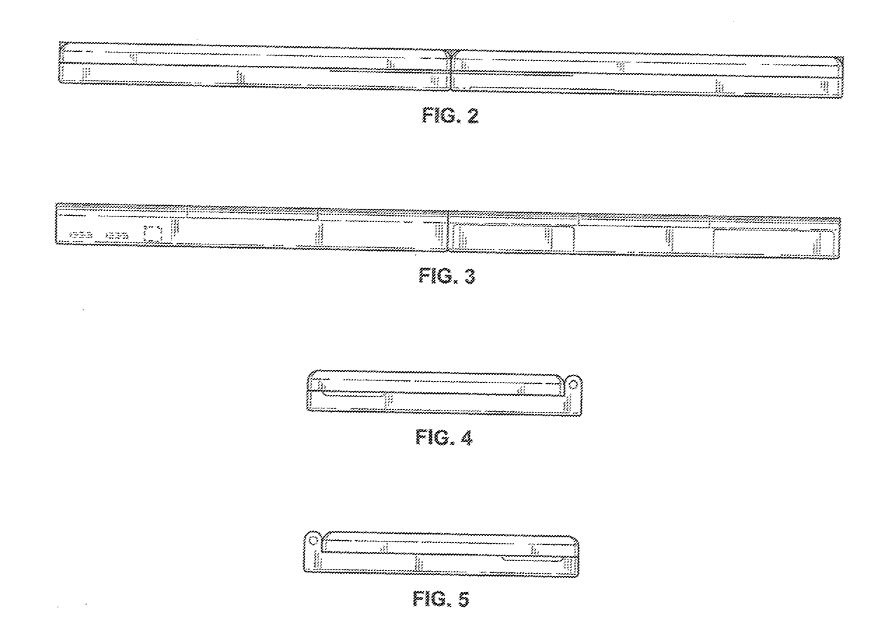

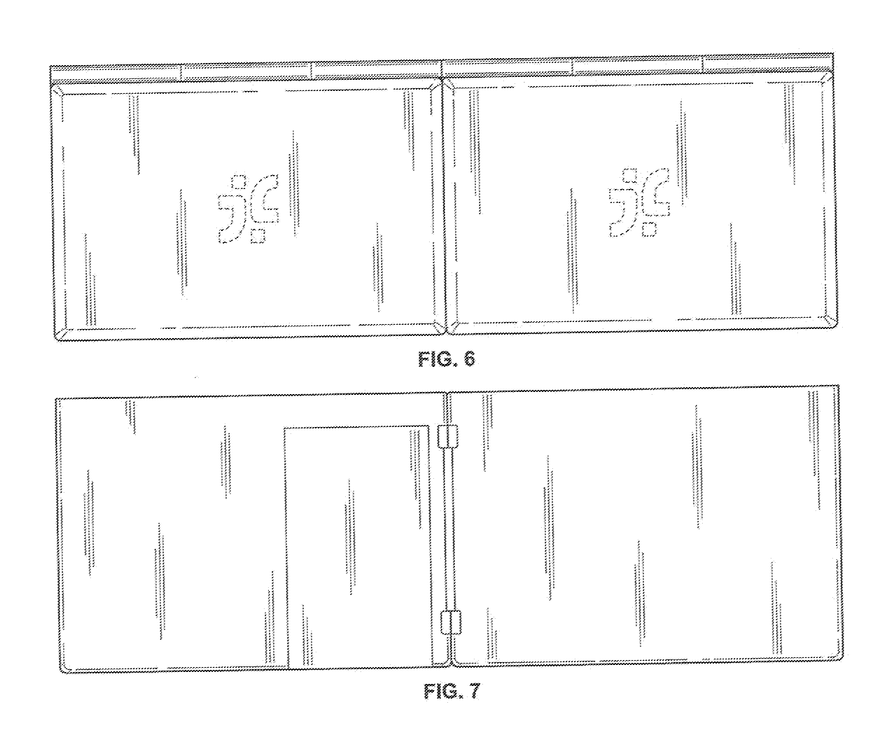

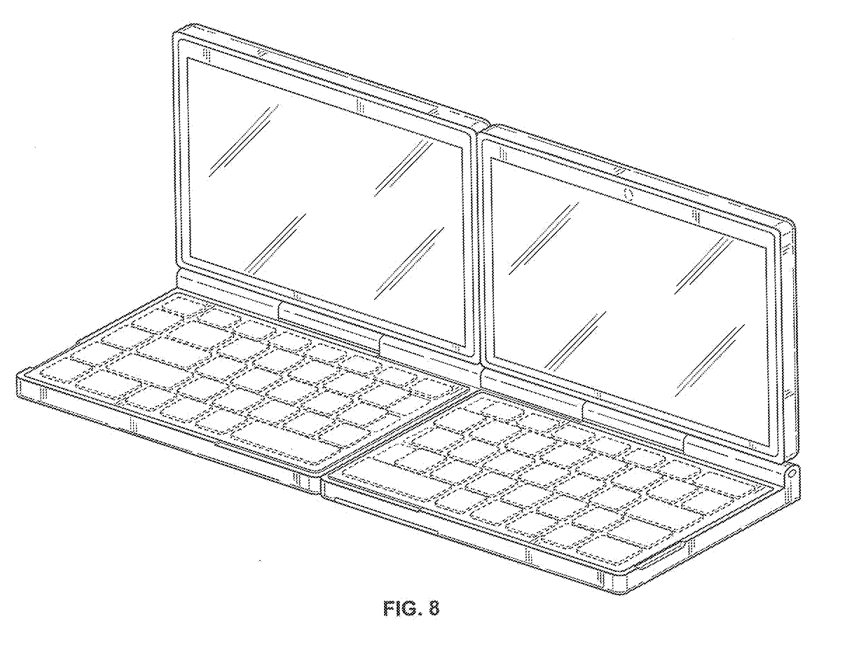

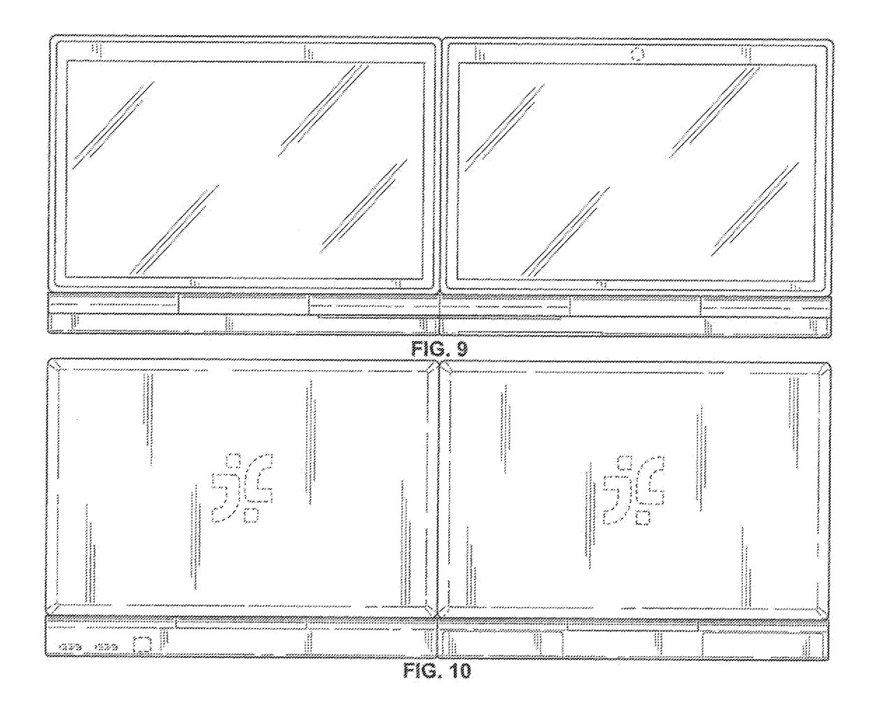

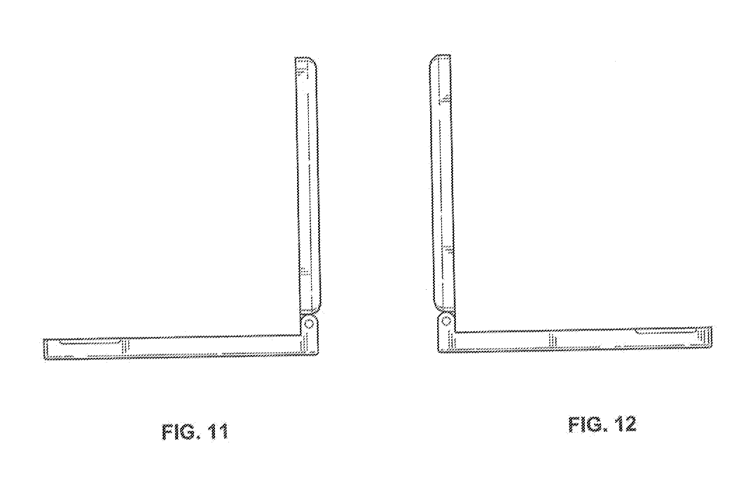

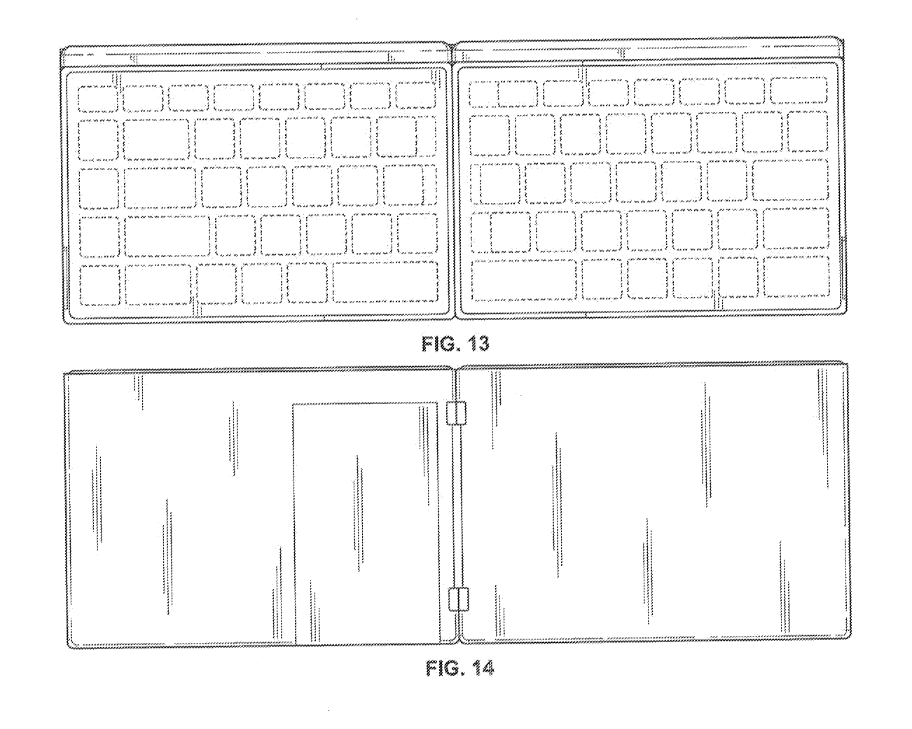

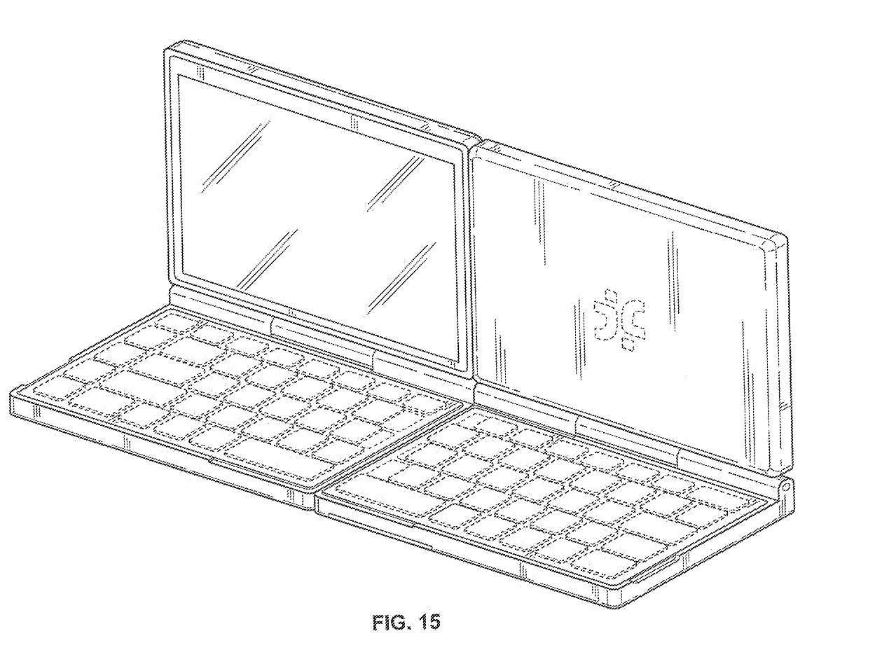

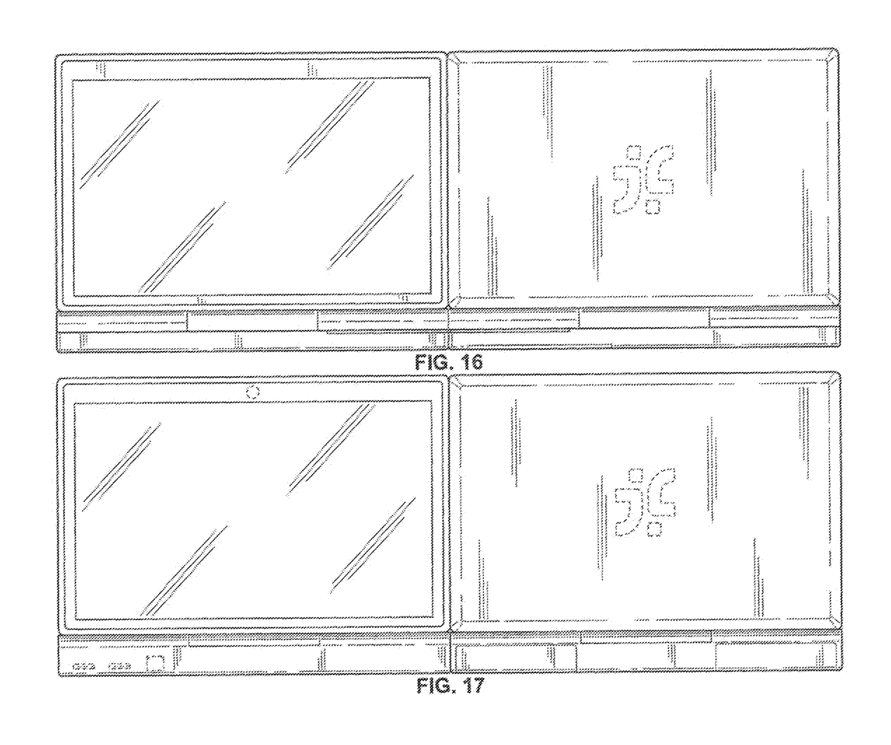

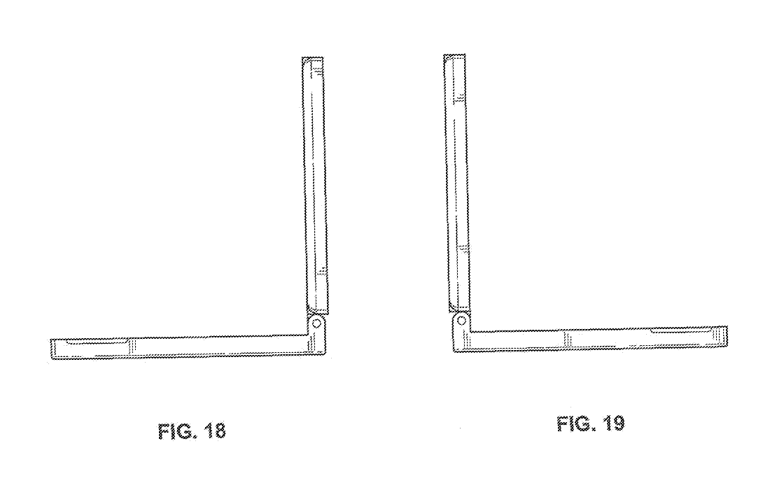

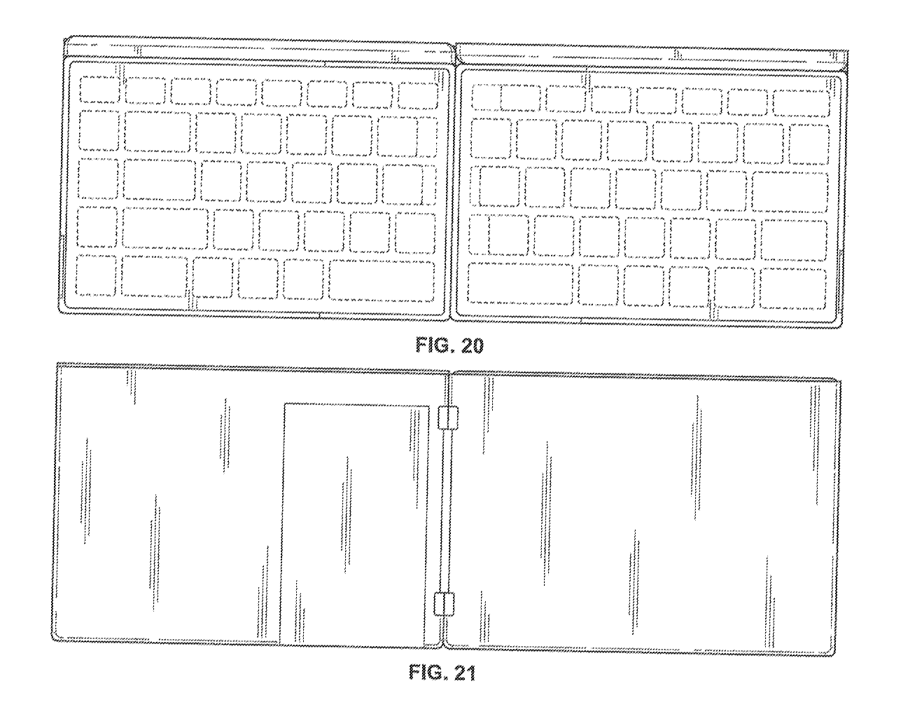

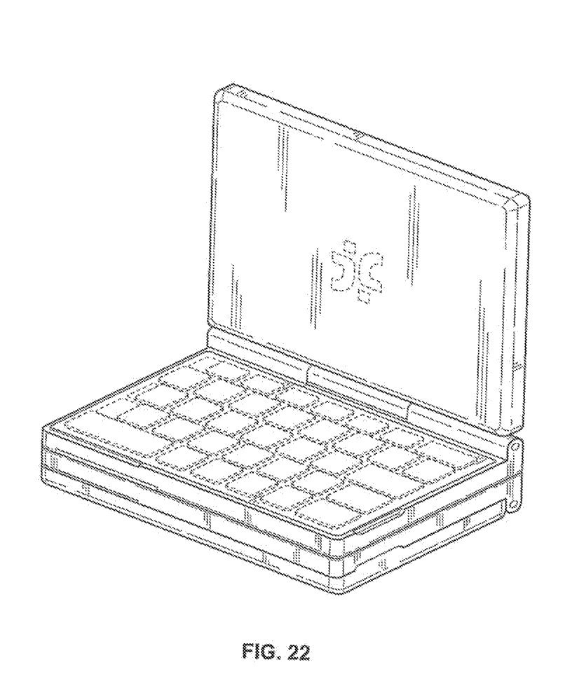

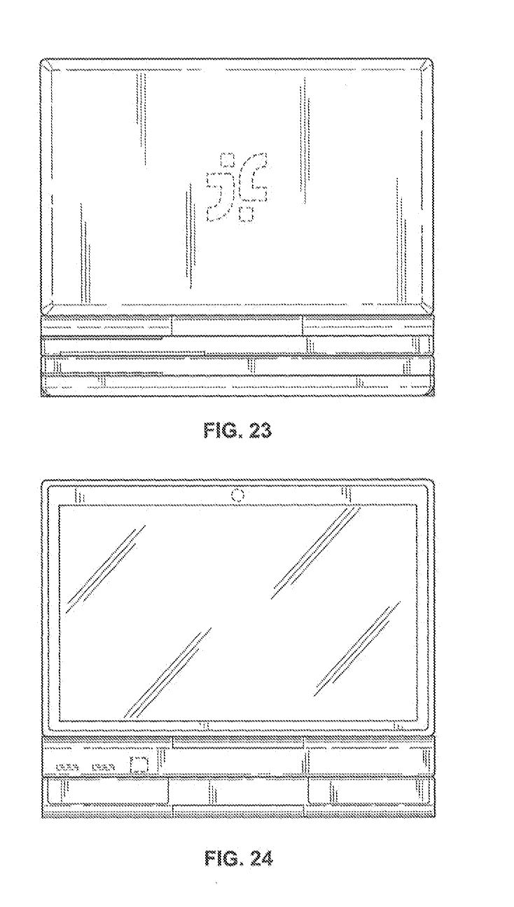

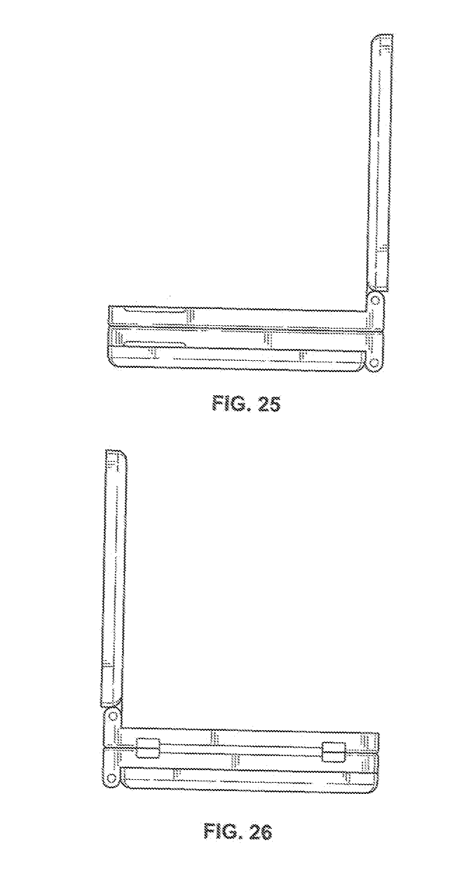

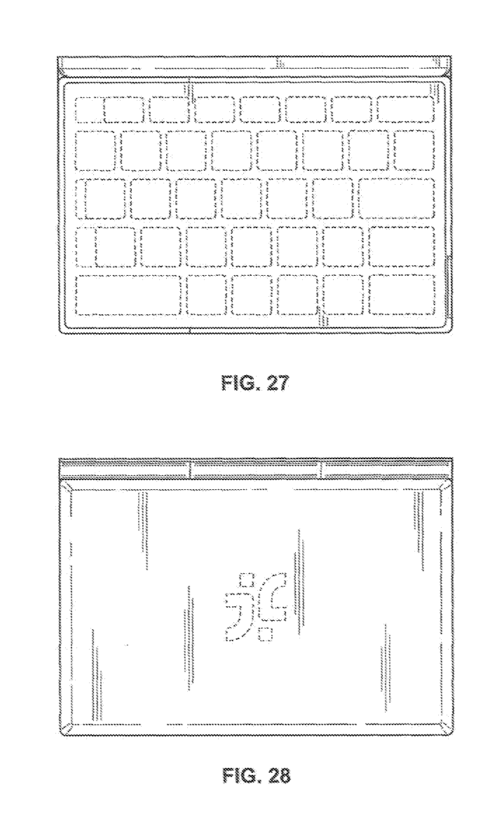

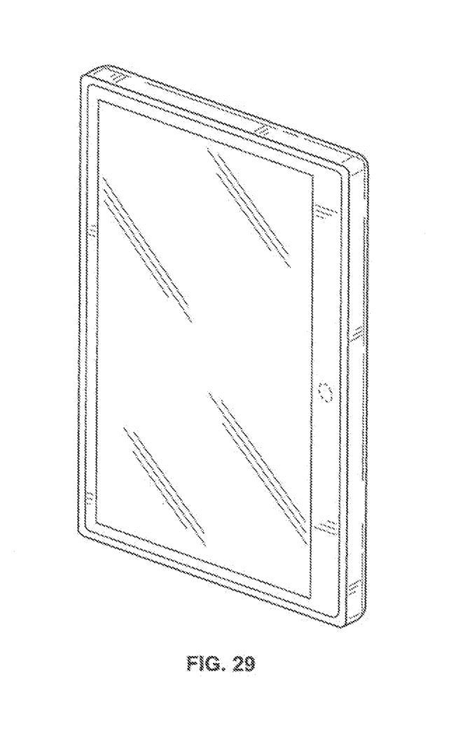

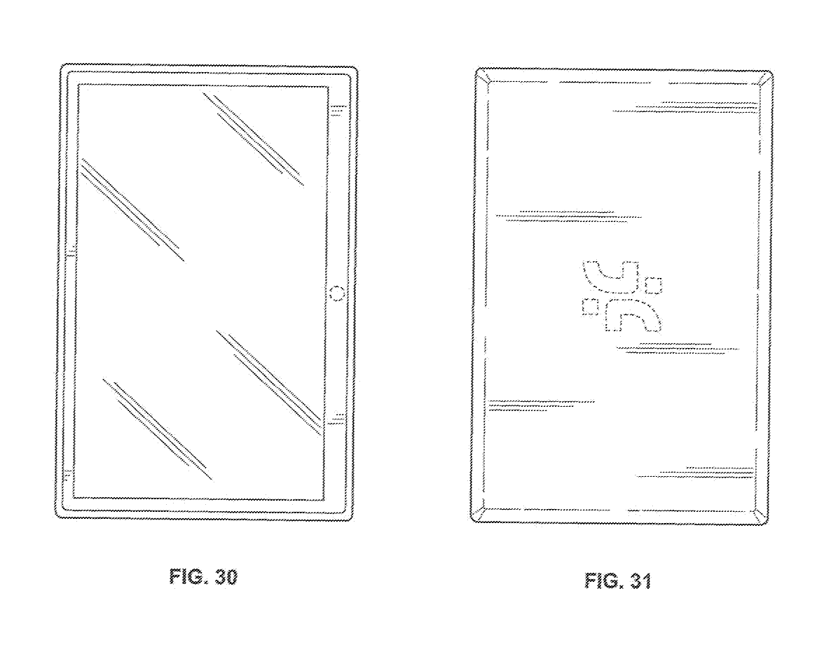

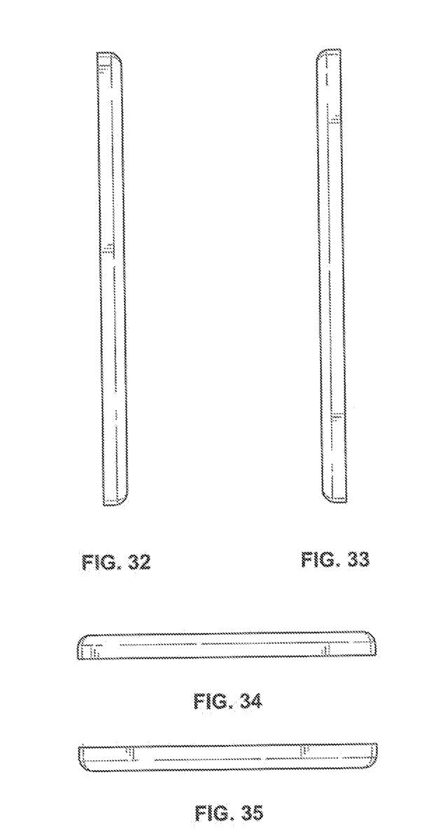

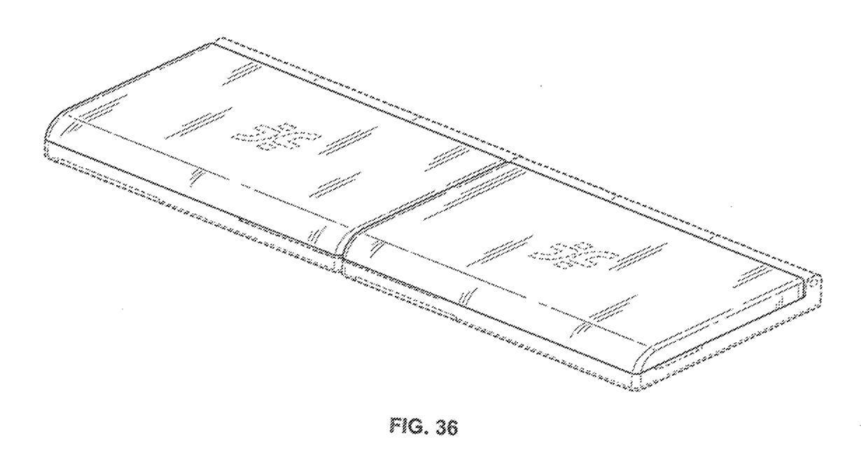

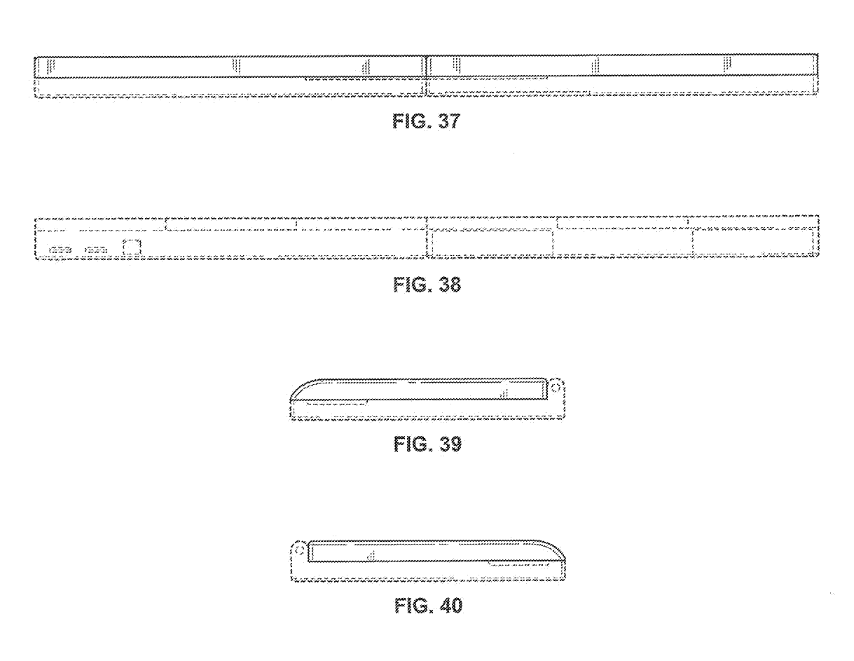

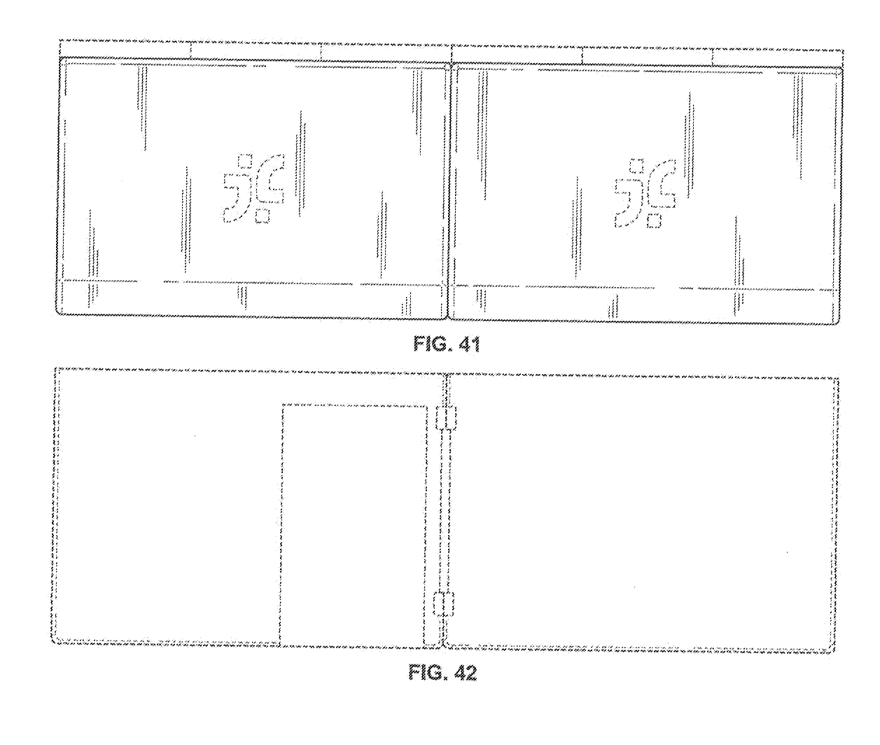

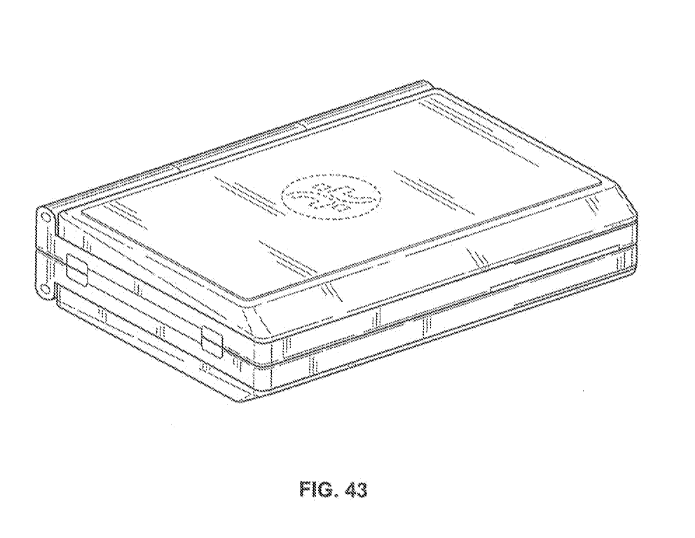

### DETAILED DESCRIPTION OF THE VARIOUS EMBODIMENTS OF THE INVENTION

The system, is designed to function as a portable, dual portrait display, full featured computer, that need not have any of the displays rotate to provide the majority of the functionality described herein. However when one or more of the displays rotate through a range of 0-180° minimum, an additional level of unique and novel functionality benefiting the operator of the system is imparted. In this regard, the system is configured to allow multiple levels of screen usage via the rotating hinges. The primary incarnations are:
One user rotates one of the displays 180-degrees to present the screen area to others sitting opposite the primary user who is controlling the device.
Two users each using an individual screens at the same time. In this mode two users are using the system with a display facing them while facing each other across the base of the unit and each having a separate keyboard and pointing device and/or using the onscreen stylus capability. In other words the two users are interacting on one system while on opposite sides of the system and feeing each other. This is accomplished by setting the system, up in the standard operational mode with both displays facing the primary user, after which, one of the displays is rotated, to face the rear of the unit, at which point the second User sits opposite the first user and then plugs in the necessary input devices via the ports on the back of the machine, thus allowing for independent or linked usage of the machine.

In this configuration, the screens are both rotated a minimum of 180-degrees for tear facing full-screen presentation, They then can be folded hack down upon the base. This allows several other configurations:
a). As one big tablet, this is characterized by having both displays rotated and then folded flat upon the base.
b). The base unit can then be folded in half at the base hinge to provide for dual opposing screens in landscape orientation.

U.S. Pat. No. 5,949,643 calls for one of the displays to be rotatable 360° for convenient displaying of the on-screen image to whomever is within the viewing area. To achieve the other uses of the taut, only one display can/should he rotated, and only 180°. This allows for several new applications:

### Two Users on One PC:

There is currently known add-in PC video card technology that allows current PCs to utilise available copious amounts of processing power and allow two or more users to share on PC and CPU (Central Processing Unit), and modern/Internet connection via this sharing or networking solution. The known technology is provided via a plug-in video card that has two video chips and a port on the hack for an included signal splitting box. This card is installed in the desktop (not mobile) PC and then the splitter box is plugged into the external port on the outside face of the card. The splitter box provides additional standard ports for the traditionally required additional monitor, keyboard and pointing device (mouse, track ball etc,). Upon successful installation, the users can boot up the FC and can then log on as individual users and even share an internet/modem connection to surf the web simultaneously or run applications independently. Users can even set up individual preferences per screen like wallpaper, icon size and style, etc, just like it truly were two separate and independent PC units. The value is that one PC can now service two or more users simultaneously (up to four with the right hardware configuration). The only major drawbacks to this solution are:
1) The cost of having to buy the additional separate hardware: monitor, keyboard, mouse, etc.

2) The configuration is certainly not a portable solution.

The current existing desktop PC solutions do not support individual sound.

The present invention brings the advantages and value of multiple users (up to four with the addition of two separate monitors as is described below) on one primary base unit This is accomplished via the built-in dual displays that rotate (either one or both). This way the unit provides for the existence of a portable two-user platform for head-to-head computing that allows for real-time collaboration and independent, computing. Furthermore, since the unit's individual displays are in close proximity to the base unit, the base mounted speakers can be easily heard. Additional speakers can be mounted in the individual display halves, so that sound can be reproduced per user. In fact, the sound signals can be split per side per user so that simultaneous sound can be reproduced. The unit can also have dual audio input and output jacks for separate headphone and microphone usage.

### Multiple Processors Availability Due to the Thermal Solution:

The multi-user mode of the subject invention has the capability of using either one processor or up to two processors (CPUs) that are designed into the physical system. This provides unlimited processing speed per user, and is possible due to the combination of the additional case area and the ensuing thermal solution as is described below. Under this configuration, one user could be using one processor and another user using the other processor offering the exact no compromise computing power of two stand-alone PCs. This has more advantages than two users sharing one processor.

### Dual Processor Mobile Workstation

The dual processors can also be linked together so that the unit becomes a dual-processing mobile workstation.

### Mechanical Design Simulates a Virtual Display:

The subject invention has the ability to expand the usable screen area to up to 4 displays that are arranged on either side of the machine and allows for a resolution of 1,024×3152 and it provides for a very minimal gap between the individual panels.

An accessory unit of the subject invention has an interlocking hinged clamshell design that conveniently houses two additional LCD screen panels for use with the system. The case will hinge in the center like a book, and upon opening, the dual portrait displays are presented to the user for viewing. The unit can be connected to the base unit intact, or the unit can be separated at the hinged halves for presentation on the desktop surface. When separated, the individual displays are then placed on either side of the main Flip-Pad units existing displays.

The unit of the subject invention can detach either the left or right display from the base unit via a hinge/connector apparatus. The signal is then sent to the detached screen via a connector equipped custom cable, or via the inhered signals generated by one or both of the two onboard infrared (I/R) windows on the base unit.

### Detachable Displays

The detachable displays may also be used as electronic tablets. In this scenario, the users can each detach a lightweight screen and connect the cables or use the built-in infrared capabilities to send the signals and use the tablets freely to enter text and take notes, away from the base unit. In this ease, the unit serves as a storable tile server to the two independent writing tablets.

For example, for convenience or when user space is limited, such as in an airplane, the unit could have either one or both of the displays detached from the base unit, and then have the cables connected between the screens and the unit, while the base unit is stored in a travel, under the seat of the aircraft The signals could also be relayed back and forth between the screen/s and the base unit via the infrared or otherwise wireless signal. In this way, one or two users can either work or play together via the tablet user configuration.

The portable computer of the subject invention has dual split base ease sections. The split hinged base of the device allows for a PC motherboard on one side and space for additional battery and flash drive storage.

The portable computer has dual operating systems and will also feature a configuration that allows for one or both displays to run as independent tablet/Smartphones running either Windows Mobile 7 and/or Google's Android Operating systems. In derail, the device can run dual operating systems; one on the PC motherboard architecture that runs either Microsoft Windows and/or Linux operating systems while each screen can run as a standalone tablet and Smartphone device and communicate back to the PC and sync the data and also can communicate with the other display.

The portable computer employs multiple methods of rotating and attaching and reconnecting the displays to the base module. The base and connected displays can feature either a rotating binge and/or also a detachable connection with a 30-pin style hard connector so that the user may detach the screens instead of merely rotating the screens 180 degrees on its axis. The detachable and reattachable nature of the displays allows the user to detach the panel, lift, remove and rotate around and reattach so that the displays can be used in either a forward feeing or a rearward facing direction.

Further the computer has multiple physical connectors to enable multiple viewing angles and screen orientation configurations. To augment the detachable and ‘reconnect-able’ nature of the displays, some users like to use displays in either portrait or landscape viewing orientation. Thus the screens each have two 30 pin connectors on each panel; one in the center of the horizontal axis of the detachable displays and also a supplemental connector along the center of the small end of the rectangular shape of the screen so that the screens may be reattached in a vertical or portrait orientation.

Because of dual, connectors of the displays, the screens may be mounted in either landscape or portrait or as a combination thereof, meaning one screen can be in landscape or horizontal viewing while the other display is also in landscape or can be detached and then remounted in portrait for simultaneous varied screen orientation viewing. In addition, either display can be either forward facing or reversed, including one facing forward in landscape and one facing rearward in portrait and all combinations thereof.

Each display may be both powered by the bass and also independently powered: Though each screen will receive power when attached to the folding keyboard base, each screen has a built-in/internal battery so that it is also able to be independently powered via this built-in battery and it can he used as a tablet/Smartphone when separated from the base. Each independent battery in the display will also recharge when connected to the folding keyboard base module.

Automatic syncing between the multiple operating systems: The simple act connecting of the display will trigger the automatic syncing of the data contained in the devices between the PC base and the Smartphone/tablet screen module (slingshot).

In attached PC tablet mode, the hinge whether via rotation or detachment and reattachment will allow for the bass section to remain fully folded and closed (screen is covering the keyboard section) and allow for one or both panels to remain attached though with the screen area facing outward (FIG. 24). In this orientation known as Attached Tablet Mode, the device becomes a touch screen PC and is using the main PC operating system instead of using the mobile tablet/Smartphone O/S such as Windows Mobile 7 or Google Android for example.

In the dual attached tablet mode, the device can have both panels attached with the screens facing outward and folded against the base, thereby covering the keyboard sections. With both panels facing outward, the base can either be folded closed for a screen on either side so that two people could view across from each other or the base can be unfolded, allowing the user to have access to two simultaneously connected touch displays, similar to handheld gaming systems (FIG. 9).

In another embodiment is a dual attached Tablet mode II that provides multiple onscreen keyboard designs and controllers. Both panels can remain attached to the base and faced upwards and therefore the screens can assume the configuration of a connected touch screen controller that can work independently or with a separate screen attached to the base module via that sections included video out port. The result is a digital onscreen keyboard that can instantly transform into a musical keyboard, drum machine or DJ mixing table.

The PC aspect of the device can function in single display roods but will have an automatic software switch that the user can enable to select between single and dual display/multi-display operating modes. Thus the separate and disconnected display can also function when detached as a standalone single tablet/Smartphone, all while the base device will continue to function as a fully operational single display PC that can have the screen orientation of either portrait or landscape.

Removable and replaceable keyboard sections may be used when detached to enhance the ergonomic positioning of the keyboards. Thus, with the ability to remove both of the split physical keyboard sections that remain fully functional via a wirelessly link to the system allows for additional ergonomic flexibility in positioning the keyboard in relation to the screen. This feature promotes optimum comfort and flexible and variable positioning of the keyboard to screen interface for the user.

The keyboard sections may be completely replaceable and swappable with custom keyboards that cater to specific applications such as mathematics or gaming. It can also comprise of swappable keyboards that replicate the physical layout of a piano keyboard or the design of a video or music editing control board. It can also accept keyboards that cater to any of the international computer keyboard language designs.

Further, the keyboard sections may be removed and the base, with internal connectors, allows for the introduction of two (2) touch screen panels to take their place thereby creating a quad-screen configuration within the devices parameters with this functionality the device can be booted into full PC mode and using the Windows O/S or other such PC computer operating systems, can allow the detached panels to operate as detached and linked touch screen PC human interface points to control the PC module.

In a further embodiment, the physical keyboards are replaced with a quad-folding housing having two additional screens that can function as a split full-size keyboard and also as an additional set of screens. This is also especially interesting since both panels can be used in a multitude of custom keyboard and keycap configurations depending on the application being used at the time. The keyboard can also be easily changed to any language and key configuration to suit and replicate all international style key arrangements. Further, the keys can change onscreen into everything from a music board, to a piano style keyboard, or to a custom remote control layout.

The subject invention may be inverted into a quad-screen design when used with detachable panels in order to create either a three and/or four-user system. In this embodiment, the two folding/detachable displays are detached and set upon a surface to create two independent panels for use by two additional users as a touch screen computing interface. The two-displays that remain attached to the folding base are then allowed to either remain flat and used with a stand or dock to be used as a linked dual-display readout or the base can then be folded in the middle at a 45 degree angle and set upon its outer edges to form a dual tented portrait display that can allow for two users to sit across from one another and see and use a single display independently.

This embodiment allows both rotating displays to be rotated rearward, which, is particularly useful for presentations to one or more individuals, wherein the main user can control the onscreen presented material by seeing exactly what is being shown on the rearward facing panels.

When using the quad-screen embodiment, it may be for use as a two-user dual display system, where the two folding/detachable displays are detached and sot upon a surface (or in a stand) side-by-side in order to create a stand-alone dual-display workstation feat can be operated via touch or augmented with a keyboard and mouse interlace. The two displays that remain attached to the base can then be set upon a surface in an upright position by being placed in a stand/dock arrangement and used as an additional stand-alone system in order to create a two-user dual display system.

The quad-screen embodiment also allows the two folding/detachable displays to be detached and set upon a surface in order to create two independent panels for use by two additional users as a touch screen computing interface. The two displays that remain attached to the folding base are then allowed to either remain flat and used with a stand or dock to he used as a linked dual-display readout or the base can then be folded in the middle at a 45 degree angle and set upon its outer edges to form a dual tented portrait display that can allow for two users to sit across from one another and see and use a single display independently, are then undocked from the base and used in the same manner by two additional users.

It is notable that the device will also support up to at least four (4) simultaneous keyboard, mice or drawing pad input combinations via USB (wireless or wired) and/or Bluetooth connections in order to provide either three or four independent and linked workstations.

Software can be provided that enables the multiple viewing angles and screen orientation configurations including,
i). One attached PC screen and one tablet/Smartphone screen.
ii). The device can also be operated with two attached PC screens working as one large desktop.
iii). Two attached screens where one is working as an attached PC monitor and the other is mirrored and able to be detached and also rotated from portrait to landscape on the fly.
iv). Two displays that can operate as dual tablets for multi-user and multi-player action.

Further software can be provided that enables multiple user and screen orientation configurations so that multiple users may use the detached panels and/or keyboards to interact with either the base and one another in the form of a mini-network as an integrated set of users ah simultaneously sharing the PC or tablet hardware/software. Depending on whether it is a dual or quad-display system being operated, the software can also work, in any combination, thereof, whereas there are two dual display users sharing the PC, or four users, each using one display, or one user operating four displays. Also, there may be one user using dual-displays and two additional users each, using a single display.

Also, a user can use the base PC to control allot using the tablets [or dual display tablet and PC] or a combination thereof wherein they are simply independent systems that co-communicate when needed.

Utilising multiple ports on the base of the device that allow for simultaneous video and audio signals to be sent to the monitors, the device can also connect additional displays of multiple screen sizes and resolutions to provide for additional and expandable multi-display environments beyond the single and dual display modes previously described herein.

The monitors can also be connected to one another when detached from the base and used as an interconnected dual display tablet/Smartphone and/or eBook.

Further, both displays can also be detached and communicate directly with the other screens as a multi-user ad-hoc tablet/Smartphone network.

Due to the dual display and multiple configurations of the device, one screen can be operated by the presenter to control the presented data and the second display can serve as a ‘dumb terminal’ or presentation device that will allow the viewer to passively view what is presented. This is useful as a presentation device in lieu of a projector. When used as a presentation device, the passive panel can be enabled to send and receive additional commands so that the viewer may interact with the presenter to provide feedback, use the screen as an electronic signature pad in order to digitally sign an agreement, etc.

The subject invention may include a docking station to a single fully-functional tablet (that does not comprise the PC motherboard architecture inside the base of the device) that is then able to be docked with the separate folding keyboard/processor docking station base that includes and encompasses an additional display thereby providing a base that can house additional batteries, hard/flash drive storage, a built-in power supply and of course a second display and full size keyboard and slide-out touchpad Pointing Device.

Due to the touch screen and interconnected nature of the architecture, the detached panels can remotely control the onscreen PC Operating System in the form of a remote touch screen controller and/or a drawing pad that can farther be augmented with the addition of a stylus (though ft will still operate with finger touch control). This is especially true if a larger panel is attached to the base via the video output ports. This will allow the user to sit back from the display and still interact and control the onscreen information using the tablet as the remote control apparatus.

Due to the nature of at least one display containing a cellular connection and antenna, the independent Smartphone/Tablet module can also work with the base as a cellular hotspot hub for one or both screens, plus the base module. This will also allow for additional unconnected devices to tether to the hotspot.

The subject invention can also function as either an interconnected set of displays both operating under the tablet/Smartphone O/S's in order that two or mote users can link the screens and use as an interconnected network thus providing essentially two Smartphone/tablets per device sold.

One or both of the attached primary hinged panels is able to be rotated through the range of either 180 degrees with a hard stop or a full 360 degrees via its central axis.

The device of the subject invention may also he stripped of its internal PC and tablet/Smartphone dedicated hardware and software and be replaced with specialized hardware and software that allows the device to serve as an inexpensive yet mufti-display and folding keyboard network computer. This can he running a network based O/S such as Google Chrome.

Further, the portable computer of the subject invention can also be connected to a PC hub wirelessly and will allow for the creation of a multi-display and folding keyboard ‘dumb-terminal’, one that is a Wi-Fi enabled and will inexpensively provide the user with an easily transportable and foldable keyboard base that provides the added functionality to the two-display multi-user system that uses external processors and even the network (cloud-based computing) as the central processing core.

Due to the detachable and self-contained nature of the supplemental processing power contained within one or more of the panels, the system of the subject invention will allow for users to upgrade the panels over time with new and improved versions and thereby extend the functional and usable life of their device. The device will self recognize the new and upgraded panel and via software will allow for the upgrade to take place instantly. Further, if there were damage to the screen, a replacement screen can be fitted instantly, unlike a standard laptop computer that would need to be dismantled by a skilled technician to affect a repair. The device will self recognize the replacement panels and allow for the repair and replacement to fake place instantly. Also, the screens will also allow for failure to at least one panel while allowing the device to function simply because them is a backup monitors. Once a failure is detected at the screen level, the software self recognizes the fault and will power down and route all video signals in proper sequence to the remaining panels. The software will also allow for the reconfiguration of the onscreen data to be properly displayed on the remaining connected panels.

1. A portable computer comprising:
a primary frame configured to operatively support a display screen formed of at least two independently pivotal display screens rotatably coupled to the primary frame by a connecting mount, each of said display screens configured to rotate in at least two planes, each plane being perpendicular to the other;
the said display screen being capable of removal from said primary frame connecting hinges allowing pivotal movement of file display screen from a first position parallel to the plane of the primary frame, to a second position perpendicular to said primary frame and to a third position intermediate the first position and the second position.

2. In a portable notebook or portable computer having a main frame and a display-screen, the improvement comprising:
said display-screen being operatively connected to a portion of said main frame;
said display-screen further having two independently pivotal display screens rotatably coupled to said main frame via a pivot-mount;
said pivot-mount mounting each of said display screens for rotation in at least one plane, and providing at least 180 degrees of movement to said display-screen;
said pivot mount allowing said movement in order to position said display-screen to a first position parallel to a plane of the maim frame and to a second position perpendicular to a plane of the main frame;
said display screen further being capable of being mechanically disengaged from said main frame while maintaining the operative connection thereto.

3. In a portable notebook or portable computer having a main frame and display-screen means;
said display-screen means further comprising at least two independently pivotal display screens each of said display screens and rotatably coupled to said main frame via a pivot-mount and being removable from said main frame;
said pivot-mount mounting one of said display screens for rotation in at least two planes, said at least two planes being perpendicular to each other;
said pivot-mount comprising a mounting arm having a first end connected to a portion of said main frame, a second end connected to a portion of said display-screen, a first pivot mount at said first end for pivotally mounting said display-screen to said main frame for movement in one said plane, and a second pivot mount at said second end for pivotally mounting said displays-screen for movement in both said planes;
said second pivot mount allowing rotation of said display-screen in the other of said planes so that said display screen may assume one of a portrait orientation and landscape orientation.

4. The portable notebook or portable computer according to claim 3, wherein one of said planes is vertical plane.

5. The portable notebook or portable computer according to claim 4, wherein said at least two planes are vertical planes.
